(19) United States
(12) Patent Application Publication
(10) Pub. No.: US 2018/0020295 A1
(43) Pub. Date: Jan. 18, 2018

(54) PERSONAL LISTENING DEVICE, IN PARTICULAR A HEARING AID

(71) Applicant: EXSILENT RESEARCH B.V., Amsterdam (NL)

(72) Inventors: Aeldrik PANDER, Den Haag (NL); Jan Marinus ALTENA, Markelo (NL)

(21) Appl. No.: 15/556,850

(22) PCT Filed: Mar. 10, 2016
(86) PCT No.: PCT/NL2016/050169

§ 371 Date: Sep. 8, 2017

(30) Foreign Application Priority Data
Mar. 10, 2015 (NL) 2014433

(51) Int. Cl. H04R 25/00; H04R 25/02

(52) U.S. Cl. CPC H04R 25/407; H04R 25/556; H04R 25/453; H04R 25/652; H04R 25/02; H04R 25/552; H04R 2225/021; H04R 2225/025

(57) ABSTRACT

A listening device comprises a device housing (10,40) worn in the ear, a device housing (20,25) worn outside the ear and an electronic circuit which is divided over the two device housings (10,20). The first device housing comprises an electro-acoustic converter (13) and a first microphone (11). The electronic circuit comprises at least one further microphone (12,21,22). A signal processing device (23) comprises at least one signal input to which the first microphone (11) and the at least one further microphone (12,21,22) are electronically coupled so as to generate a microphone signal thereto. The electro-acoustic converter (13) is connected to a signal output of the processing device (13) which is at least loadable with a processing algorithm and is thus able and configured to calculate and present the output signal as algorithmic resultant of at least the microphone signals from the first microphone (11) and the at least one further microphone (12,21,22).

The present invention relates to a personal listening device, in particular a hearing aid, comprising a part worn in the ear intended and configured to he received positioned wholly in an auditory canal of a user, comprising a part worn outside the ear intended and configured to be worn outside the auditory canal of the user, and comprising an electronic circuit. wherein the part worn in the ear comprises a first device housing in which a first part of the electronic circuit is accommodated, and wherein the part worn outside the ear comprises a second device housing which provides space for a second part of the electronic circuit.

Such a listening device can take many forms, varying from a hearing aid for the deaf and hard of hearing, a listening support device, also referred to as an assistive listening device (ALD), and earphones and headsets for audio reproduction and active noise suppression, also referred to as a personal sound amplifier and active noise cancellation, to active sound filters. Characteristic for these devices is a microphone for receiving and converting ambient sound to a corresponding electronic signal, and a signal processing device which supplies this signal in amplified and/or otherwise processed form to an electro-acoustic converter (often referred to as transducer, receiver, speaker or loudspeaker) for the purpose of presenting the received sound in modified, auditively improved form to the hearing of the user. The ambient sound can thus be amplified for the purpose of an improved audibility, or harmful or irritating components can be filtered therefrom or the ambient sound can be attenuated in order to protect the hearing from hearing impairment.

A device of the type described in the preamble is for instance known from International patent application WO 2008/010716. The device described herein comprises a part worn in the ear which is received in a first device housing and received deeply, and thereby wholly concealed, in an auditory canal of the user. This device housing comprises the electro-acoustic converter and the microphone. In addition, the known device comprises a second device housing worn wholly outside the auditory canal of the user, behind or on the ear.

Present herein is an electronic power source such as an optionally rechargeable battery. Also situated in the second device housing is the signal processing device which draws its electric power supply directly from the power source. For the purpose of a mutual electronic connection of the two parts of the device a multi-core cable connection is arranged therebetween which provides an electric power supply to the in-the-ear part and a signal transfer between the two parts of the electronic circuit together formed by the electronic components of the part worn in the ear and the part worn outside the ear.

The placing of the microphone with the loudspeaker in the in-the-ear part of the known device contributes significantly toward a natural perception of sound in that use is advantageously made here of an acoustic interaction between the captured sound and the natural anatomy of the auditory canal of the user. Listening devices known thus far nevertheless still do not provide a user with a fully natural perception of the sound. In particular a reduced perception of direction in the experienced sound and occurring background noises undermine such a natural reproduction.

The present invention has for its object, among others, to provide a listening device with which a user can be given a more natural perception of the experienced sound.

In order to achieve the stated object a listening device of the type described in the preamble has the feature according to the present invention that the first part of the electronic circuit comprises at least an electro-acoustic converter and a first microphone, that the electronic circuit comprises at least one further microphone, that the electronic circuit comprises a signal processing device with at least one signal input to which the first microphone and the at least one further microphone are electronically coupled so as to generate a microphone signal thereto, and with at least one signal output to which the electro-acoustic converter is connected, and that the signal processing device is at least loadable with a processing algorithm and is thus able and configured to calculate and present the output signal as algorithmic resultant of at least the microphone signals from the first microphone and the at least one further microphone.

Because the processing device is thus supplied with input signals from various spatially separated microphones and is loaded with a processing algorithm specifically adapted thereto, both direction and background noise in the experienced spectrum can be identified as such and at least partially included in the output signal or filtered therefrom. The quality and audibility of the sound ultimately generated to the user can hereby be considerably improved in various ways.

A first preferred embodiment of the listening device according to the invention has in this respect the feature that the second device housing is intended and configured to be worn outside the auditory canal on an auricle of the user, and that the second part of the electronic circuit comprises at least one further microphone provided close to an upper side of the second device housing. With such a placing of one or more microphones on the upper side of the second device housing, i.e. at the position of the upper side of the pinna (auricle), the effect of a traditional directional microphone can be obtained. The microphone signals from the at least one further microphone are used here as addition and improvement to the microphone signal from the first microphone which is positioned in the in-the-ear part and receives its sound via the auditory canal. Because the at least one further microphone is placed on the upper side of the second device housing, there is sufficient correlation and spectral correspondence between the signals from the first microphone in the ear and this (these) directional microphone(s) outside the ear to apply the signals auditively within a processing algorithm which is adapted for this purpose and with which the signal processing device is loaded. Impulse sounds can be used to mutually attune the microphones in respectively the part outside the ear and the in-the-ear part. A calibration can be performed in order to precisely determine a difference in travel delay between the microphones. This difference in travel delay is particularly relevant in obtaining an improved directing action for the lower frequencies. Because the spatial distances between the positions of the microphones can differ for each individual, determining of such differences in travel delay is preferably performed separately per individual. By presenting sound from a specific direction for this purpose the relative difference in travel delay between the microphones can be precisely determined and stored in the device. It is also possible during the daily use of the device to use determined specific sounds in order to thus determine differences in travel delay. This can be achieved for instance by periodically verifying the microphone position for the differences in travel delay on the basis of impulse sounds which occur regularly during use.

A particular embodiment of the listening device according to the invention is characterized here in that the signal processing device loaded with the signal processing algorithm is able and configured to apply a time correction between the microphone signal from the first microphone on the one hand and the one or more microphone signals from the at least one further microphone on the other. It is thus possible to compensate the output signal for the difference in distance in the horizontal plane between the first microphone in the ear and the at least one further directional microphone outside the ear. The final correction depends on the distance between the first microphone and the further microphone(s) and can be a fixed input or dynamically determined by taking measurements of impulse sounds in the frontal plane.

The above described directional sensitivity of the listening device can be optimized in a particular embodiment which is characterized in that the at least one further microphone comprises a group of a number of spatially separated microphones provided close to an upper side of the second device housing.

A second preferred embodiment of the listening device according to the invention has the feature that the second part of the electronic circuit comprises at least one further microphone provided on a rear side of the second device housing. Through such a placing of one or more microphones on the rear side of the second device housing, and thereby on the rear side of the pinna/auricle, this (these) microphone(s) is/are shielded by the pinna, whereby determined frequencies in the frontal sound are experienced at a different level. By experiencing the level, spectral and phase differences between on the one hand this (these) microphone(s) shielded on a rear side and on the other the first microphone located in the first device housing in the auditory canal and facing forward it becomes possible to make a distinction in the processing algorithm between frontal sound and sound from behind. In a particular embodiment of the listening device according to the invention, characterized in that the at least one further microphone comprises a group of a number of spatially separated microphones provided on a rear side of the second device housing, this mechanism can be further implemented and this effect can be further optimized.

Allowance can thus be made in the processing algorithm loaded into the processing device for a direction of origin and other characteristics of background sound and conditions and parameters can be set therein which determine how the microphone signal from the first microphone must be processed in relation to the microphone signal from the at least one further microphone.

The characteristics of the background interference sound can be detected by an at least one microphone on the rear side of the second device housing, while a directional sensitivity can be imparted by an at least one microphone on an upper side thereof. These values can be used to control a processing filter or noise cancellation algorithm so that the signal from the first microphone can be processed and improved such that the output signal generated to the electro-acoustic converter much better represents a natural perception. The sound eventually generated to the eardrum of the user will hereby be perceived by him/her much more as natural sound, i.e. sound as a person with normal hearing would perceive it.

An additional advantage of the listening device according to the invention is that the described signal processing takes place only when the (interference) sound is present, so only at the moment that it is necessary or desirable. When no interference sounds are present, the noise suppression can be switched off in order to achieve a natural and non-damped transmission of the microphone signal from the in-the-ear first microphone.

In a third preferred embodiment the listening device according to the invention has the feature that the first part of the electronic circuit comprises at least one further microphone with a sound entrance oriented toward an entrance of the auditory canal, and more particularly that the at least one further microphone comprises a group of a number of spatially separated microphones, each with a sound entrance oriented toward the entrance of the auditory canal. With such a configuration it is possible to determine the direction of origin of the sound discerned by the microphones of the in-the-ear part of the device and to have this taken into account as such in the processing algorithm of the processing device.

A further particular embodiment of the listening device according to the invention has the feature that the first part of the electronic circuit in the in-the-ear part comprises at least one further microphone with a sound entrance oriented toward an eardrum of the user.

Positioning at least one further microphone on the eardrum side of the first device housing enables measurement of a sound pressure close to the eardrum. this information can be used to measure the acoustic response of the auditory canal and to make corrections to the reproduction. Continuous measurement of the sound pressure close to the eardrum makes it possible to determine the exposure to sound over longer periods (dosimeter function). It is hereby possible to employ a regulating function in applications wherein audio signals are reproduced in the ear for a longer period of time, such as for instance during music playback. Another application would be to add an environment function. Sounds caused by occlusion can be suppressed here.

When a microphone is also applied on the auditory canal side, it is moreover possible to discriminate between secondary sound from the ear, i.e. from the eardrum side, and primary sound received directly via the auditory canal. On the basis hereof a feedback suppression algorithm can be configured with which an extremely irritating acoustic feedback, also referred to as whistling, can be suppressed to significant extent, or at least becomes better controllable in changing conditions. A difference in travel delay and sound volume between the signals from the microphones receiving respectively the primary sound and the secondary sound can be used to suppress such an acoustic feedback component in the signal.

In order to optimize such a feedback algorithm a so-called feedback response path can be measured. This measurement entails a specific stimulus being generated in the ear via the loudspeaker and the signal leaving the ear then being measured. In existing listening devices such a measurement can only be initiated during a fitting process and is therefore usually performed only once. The characteristic of the feedback response path can however change significantly during wearing of the device. among other reasons because the device is worn differently, through the use of (different) earpieces or shifting of the device, whereby a feedback algorithm, once set, functions less well.

When the user changes hearing program, an auditive indicator is often used in practice in order to indicate which program has been selected. A change in auditive indicator can be registered by the listening device according to the invention and be employed as trigger for measuring the feedback response path again. Because of the presence of the group of first microphones suitable for the purpose in the in-the-ear part of the device this can be carried out wholly independently by the listening device according to this third preferred embodiment, whereby the values and parameters used in the feedback algorithm are regularly verified and assessed for their correctness. These values are if necessary modified on the basis of a current measurement.

This method functions optimally when the probe microphone(s) is/are placed close to the secondary source. The further removed the probe-microphone(s) is/are located from the secondary source, the much more weakly discernible the signal from the auditive indicator will be, and the sound level of the indicator would have to be much higher to obtain usable results from the measurement. This would result in unpleasant and impractical sound levels.

Because of the placing of the at least one further microphone in the in-the-ear part in which the secondary sound source, i.e. the electro-acoustic converter, is also accommodated, this at least one further microphone can be utilized particularly advantageously as such probe-microphone at short distance. A regular probing of the feedback response path and verification of values set therefor can thus be performed, particularly at the normal sound levels of the acoustic indicator, because the at least one further microphone is placed close to the opening of the auditory canal and the stimulus being delivered to the ear can be picked up clearly; even in less than ideal conditions, such as in the case of ambient noise. The thus obtained information can also be used to determine the in-ear response. It is hereby also possible to verify whether the settings of the hearing aid still match the acoustics of the auditory canal or whether a correction has to be made thereto.

An acoustic separation and insulation of the proximal side of the in-the-ear part facing toward the ear entrance with at least the first microphone and the distal side facing toward the eardrum to which the output signal is generated by the electro-acoustic converter is desirable in all cases in order to suppress as far as possible an undesired feedback of the latter sound to the microphone(s). With this in mind, a further particular embodiment of the listening device according to the invention has the feature that the second device housing is received in a deformable sleeve which is able and configured to adjust itself to a local natural anatomy of the auditory canal. The adaptability of the deformable sleeve thus provides for a close fit to the wall of the auditory canal so that undesirable parasitic acoustic paths between the in-the-ear part of the device and the wall of the auditory canal are limited to a minimum.

In order to nevertheless provide wearer comfort a further particular embodiment of the listening device according to the invention has the feature that the sleeve comprises at least one ventilating channel which provides an open air pathway between a proximal side facing toward an entrance of the auditory canal and an opposite distal side thereof facing toward the eardrum. Because of the thus created ventilating channel the occurrence of a pressure difference between the two sides of the second device housing is effectively prevented. Such a pressure difference in the auditory canal could otherwise manifest itself on the eardrum in the form of a perceptible or even audible interference of the hearing, normally referred to as occlusion.

A further advantageous embodiment of the listening device according to the invention has the feature that the second part of the electronic circuit in the second device housing comprises at least the signal processing device and an electronic power supply. Because the second device housing is worn outside and not inside the auditory canal, it may be considerably more voluminous. A heavier power source can hereby be applied for the purpose of an extended operating time of the device. The processing device and optional further electronics which do not definitely have to be accommodated in the first device housing worn in the ear are advantageously also accommodated in the second device housing so as to thereby save space and volume in the first device housing.

Recommended from a logistical viewpoint is a further preferred embodiment of the listening device according to the invention which is characterized in that the first part of the electronic circuit and the second part of the electronic circuit are mutually connected by means of a cable connection between the first device housing and the second device housing, and that the cable connection comprises on at least one outer end a connector for a releasable connection to at least one of the first device housing and the second device housing. Owing to the mutual releasability of the two parts of the device because of the releasable connector(s) of the cable connection it is thus possible to suffice with fewer separate components and parts in the case of stock supplies, maintenance or repair.

The invention will now be further elucidated on the basis of an exemplary embodiment and an accompanying drawing. In the drawing:

FIG. 1 shows an exemplary embodiment of a listening device according to the invention;

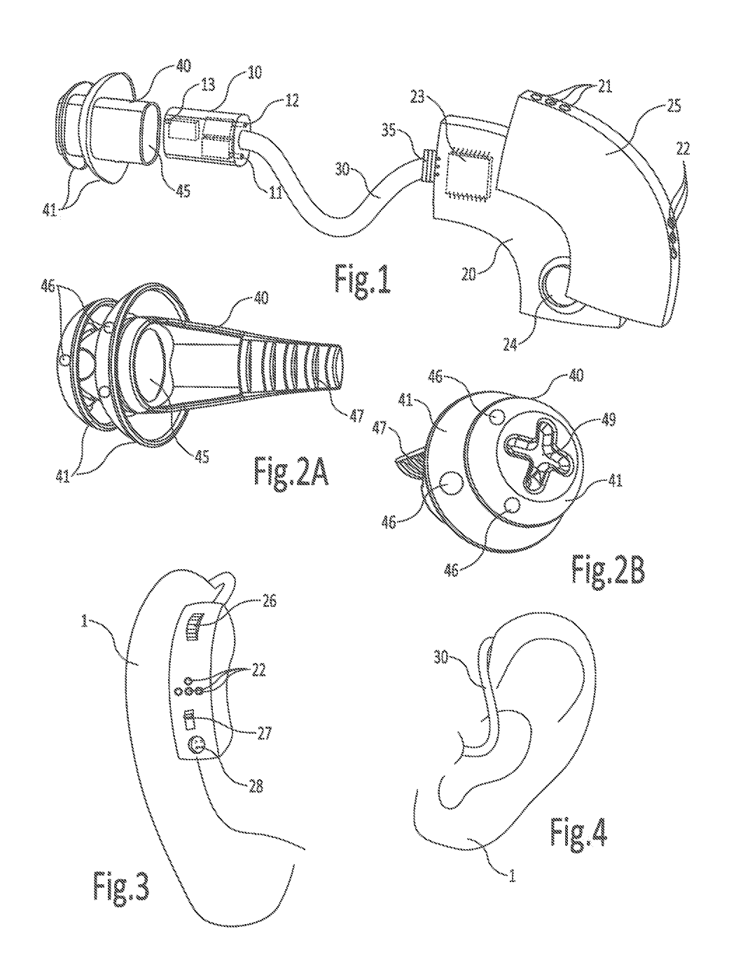

FIG. 2A, 2B show respectively a side view and front view of an exemplary embodiment of an alternative deformable sleeve for receiving the second device housing of the listening device of FIG. 1;

FIG. 3 shows the listening device of FIG. 1 worn on and behind the ear of a user and as seen from behind the user;

FIG. 4 shows the listening device FIG. 1 worn on and behind the ear of a user as seen in front view of the user;

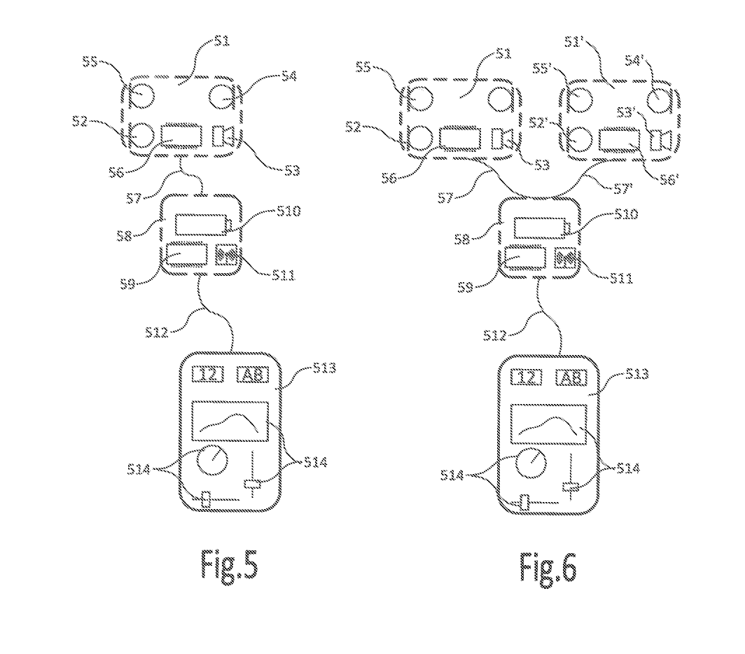

FIG. 5 shows schematic representation of a second embodiment variant of the listening device according to the invention.

The figures are otherwise purely schematic and not drawn to scale. Some dimensions in particular may be exaggerated to greater or lesser extent for the sake of clarity. Corresponding parts are designated in the figures with the same reference numeral.

The listening device shown in FIG. 1 is applied as hearing aid in order to at least partially compensate hearing loss of a hearing-impaired user so that the user can continue to function normally. The device comprises for this purpose a part 10,40 worn in the ear which is intended and configured to be worn positioned wholly in the auditory canal of the user. As such this part of the device is not visible externally to bystanders, or hardly so, see also FIG. 4. In addition, the device comprises an outside-the-ear part 20,25 intended and configured to he worn on and behind ear 1 of the user. see also FIG. 3. The two parts are connected both mechanically and electronically to each other by means of a cable connection 30 which extends between the two parts and is connected releasably by means of a connector 35 provided thereon to the outside-the-ear part 20 of the device.

With a view to an acoustically and ergonomically good fit of the in-the-ear part of the device, the first device housing can be adjusted in respect of an outer contour thereof to the natural anatomy of the auditory canal at the location where the in-the-ear part will come to lie. This requires precision work and modelling technique which should normally be left to a hearing specialist (audiologist) specially trained for the purpose. Use is normally made here of a curable plastic which, after being modelled to size in plastic state for the auditory canal of the user, is exposed to actinic UV light in order to cure to a form-retaining whole in the shape determined by the specific anatomy of the user. Although a device housing to size can thus be obtained, the wearer comfort nevertheless often still leaves something to be desired in practice. The auditory canal can also deform in the course of time or the device housing can shift, whereby an initially correct fit is no longer present.

In order to enable use of a more or less standard component for the in-the-ear part instead of a component made precisely to size, which is desirable from a logistical and manufacturing viewpoint, the in-the-ear part comprises in the present embodiment a form-retaining device housing 10 which is received in a separate outer casing 40. Device housing 10 provides space for a first part of an electronic circuit of the device. The device housing as such comprises a microphone 11 and an electro-acoustic convertor 13, which is also referred to as receiver, loudspeaker or transducer, and is able and configured to convert an electronic audio signal to acoustic sound which is emitted more or less directly to the eardrum. Because device housing 10 is inserted into a separate outer casing 40 and the outer casing thus provides for the fit in the auditory canal, device housing 10 can be a component of more or less standard form independent of the anatomy of the user, this providing a significant advantage from a logistical viewpoint.

In order to obtain a fitting unit in respect of in-the-ear part 10,40 use can be made for the separate outer casing 40 of a form-retaining and often relatively hard measured piece, for instance of a plastic curing under the influence of visible or invisible light, this being made to measure by an audiologist as described above. Instead of such a relatively hard conventional material, use is however made in this embodiment of a relatively soft, deformable plastic from which a slightly compressible, deformable sleeve 40 is manufactured. This sleeve 40 is provided externally with one or more flexible fins 41 which impart to sleeve 40 an extra capability of shaping and adjusting itself in place to the specific anatomy of the auditory canal for the purpose of a good connection and fitting as well as an improved wearer comfort compared to the hard, form-retaining plastic applied for made-to-measure products. Sleeve 40 internally comprises a cavity 45 into which the form-retaining device housing 10 is inserted and, with this in mind, the dimensions of which are adapted to those of the device housing.

The device of the present embodiment fits here into a system in which a series of such insertion sleeves 40 are provided which differ from each other in terms of external design and dimensioning so that a fitting sleeve can he found for practically any user. On a distal side, i.e. a side facing toward the eardrum, sleeve 40 comprises a sound-emitting opening in the form of a through-opening in acoustic connection with an acoustic output of loudspeaker 13 in device housing 10. As regards the material of sleeve 40, use can for instance be made of polyurethane or a thermoplastic rubber such as silicone rubber or other synthetic rubber. Applied advantageously here is a biocompatible plastic which softens under the influence of body temperature and is then able to adjust itself to the natural anatomy of the auditory canal. It is particularly possible here to opt for a gel-like plastic.

FIGS. 2A and 2B show respectively a side view and front view of a further developed embodiment of the compressible sleeve 40. A monolithic extension 47 is formed here on the sleeve and serves as pull tab with which the in-the-ear part 10,40 can be pulled out of the ear instead of having to pull on cable connection 30, as is the case in the embodiment of FIG. 1. Pull tab 47 is thus formed as an integral whole together with sleeve 40. In addition, ventilating openings 46 are provided in this embodiment in peripheral fins 41 in order to prevent or at least equalize pressure differences on either side, i.e. proximally and distally, of the in-the-ear part. Openings 46 of successive fins 41 are preferably not in line with each other, i.e. mutually offset, so that a linear parasitic sound path is suppressed, see FIG. 2B.

Device housing 10 of in-the-ear part 10,40 of the device of this embodiment also comprises on a proximal side, in addition to a first microphone 11, a second microphone 12 for capturing ambient sound. More of such further microphones can optionally be added thereto in device housing 10. Owing to the placing of such a further microphone 12 in the in-the-ear part 10 in which loudspeaker 13 is also accommodated, this further microphone 12 can be utilized particularly advantageously as probe microphone for measuring a feedback response path in the device. A regular probing of the feedback response path and verification of values set therefor can thus be performed at the normal sound levels of the acoustic indicator, because this microphone 12 is placed close to the opening of the auditory canal and the stimulus being delivered to the ear can he picked up clearly; even in less than ideal conditions, such as in the case of ambient noise. The thus obtained information can also be used to determine the in-ear response. It is hereby also possible to verify whether the settings of the hearing aid still match the acoustics of the auditory canal or whether a correction has to be made thereto.

On a distal side sleeve 40 comprises a sound-emitting opening 49, see FIG. 2B, for the purpose of emitting sound developed by a loudspeaker 13 to an eardrum of the user. Situated internally between sound-emitting opening 49 and loudspeaker 13 is a cerumen protection (not further shown) for intercepting and optionally buffering cerumen possibly secreted in the auditory canal so that it does not adversely affect the operation of loudspeaker 13. This is for instance a locally widened portion, bend or obstacle in a sound channel between loudspeaker 13 and sound-emitting opening 49 which at least temporarily blocks or intercepts cerumen.

The outside-the-ear part of the device comprises a second device housing 20 in which a second part of the electronic circuit of the device is accommodated. Second device housing 20 as such provides space for an electronic power source 24 in the form of an optionally rechargeable battery and a digital processing device 23 which is able to process and also amplify in optionally selective manner sound signals emitted by microphones 11,12 and to generate the thus processed and optionally amplified signal to loudspeaker 13.

In this embodiment a number of further microphones 21,22 are provided here according to the invention in second device housing 20 which generate additional microphone signals from different spatially separated positions to processing device 23. In this embodiment these further microphones comprise a first group 21 of spatially separated microphones provided on an upper side of the second device housing in combination with a second group 22 of further microphones arranged on a rear side of device housing 20, see also FIG. 3.

Device housing 20 is further equipped with operating members such as an on/off switch 27 and a volume button 26, so that the user can switch the device on or off and adjust it as desired. For further-reaching changes in the settings of the device, particularly the setting of a processing profile or characteristic of the processing device. the device housing moreover comprises a programming connector 15 which can be coupled to specific programming equipment of for instance a maintenance engineer or an audiologist. Arranged over device housing 20 is an exchangeable outer casing 25, the colour and shape of which can be adapted to the user. Outer casing 25 moreover covers programming connector 28 so that it is less vulnerable to the effects of moisture and contamination from outside. Operating switch 27 and volume button 26, as well as the groups of microphones 21,22 are left clear by outer casing 25.

First device housing 10, which forms part of the in-the-ear part, and second device housing 20 behind the ear are mutually connected by means of a cable connection in the form of a connecting cord 30. Connecting cord 30 comprises a number of core pairs which serve on the one hand for an electric power supply to the electronic components in first device housing 10, directly or indirectly from battery 24, and which provide on the other hand for the signal transfer from the components of first device housing 10 to processing device 23 in second device housing 20. Use is preferably also made here of a releasable cord which is inserted on one or both sides with a suitable connector 35 into the associated part 10,20 of the listening device and which can thus be adapted in length and colour to the user.

Although the invention has been further elucidated above with reference to only the foregoing exemplary embodiment, it will be apparent that the invention is by no means limited to the given embodiment. On the contrary, many variations and embodiments are still possible for the person with ordinary skill in the art within the scope of the invention. The invention thus already provides an advantage in the case of only one of the further microphones in respectively the first device housing or second device housing. It is also possible to opt for a greater or smaller number of further microphones in each of the two parts of the device, and the position can be varied.

The device housing 51 worn in the ear, see also FIG. 5, advantageously provides space for a signal processing device 56 (digital sound processor), wherein the signals from a number of microphone(s) of the device housing 52,54,55 worn in the ear are processed and loudspeaker 3 in the device housing worn in the ear is controlled thereby. In the embodiment of FIG. 5 there are two microphones 52,55 on a proximal side facing toward an ear entrance in addition to a microphone 54 on a distal side facing toward the eardrum. Although microphones 52,54,55 are actually drawn distally and proximally in the schematic figure, the microphones can in reality be provided elsewhere in device housing 51 with a sound entrance which opens respectively distally or proximally from the device housing.

The energy required for signal processing device 56 can be provided from the device housing 58 worn outside the ear via an electrical connection 57 or be realized in other manner. The device housing 58 worn outside the ear comprises for this purpose an optionally rechargeable battery 510. Optionally standardized communication means 511 can further be provided in the device housing 58 worn outside the ear for a wireless or wired communication and electronic signal transfer to an external apparatus or device. A plug or other connection 512 to an external apparatus 513 which provides the required energy, such as for instance a telephone or computer, can for instance also be applied. An audio signal from an external sound source can then also be sent here via such an electronic connection to the signal processing device. There is then also the option of configuring and setting the signal processing device with the connected external apparatus via the electrical connection or a wireless connection. The external device or apparatus 513 comprises for this purpose one or more operating elements 514, such as controllers or a touch-sensitive screen. for changing settings in signal processing device 56 of the in-the-ear part and/or a sound processing unit 59 in outside-the-ear part 58. This latter is optional and can optionally replace that of the part 58 worn in the ear.

In the context of the invention the part worn outside the ear can also be applied in combination with a second part worn in the ear which is additional to the first part worn in the ear and which is then worn in the other ear of the user. This is shown schematically in FIG. 6, wherein this embodiment otherwise corresponds wholly to that of FIG. 5. A second device housing worn outside the ear for the second part worn in the ear can in this case be dispensed with. Apart from being worn on the ear, the part worn outside the ear can also be worn elsewhere at, on, close to or in the body of the user.

Through the use of further microphones at spatially separated positions in combination with a processing algorithm tailored and adapted thereto which can be loaded as part of processing software into the processing device and executed thereby, the invention generally provides a significant improvement in respect of the perception and quality of the sound generated to the user.

1. Personal listening device, in particular a hearing aid, comprising a part worn in the ear intended and configured to be received positioned wholly in an auditory canal of a user, comprising a part worn outside the ear intended and configured to be worn outside the auditory canal on an auricle of the user, and comprising an electronic circuit, wherein the part worn in the ear comprises a first device housing in which a first part of the electronic circuit is accommodated, wherein the part worn outside the ear comprises a second device housing which provides space for a second part of the electronic circuit, characterized in that the first part of the electronic circuit comprises at least an electro-acoustic converter and a first microphone, that the electronic circuit comprises at least one further microphone, that the electronic circuit comprises a signal processing device with at least one signal input to which the first microphone and the at least one further microphone are electronically coupled so as to generate a microphone signal thereto, and with at least one signal output to which the electro-acoustic converter is connected, and that the signal processing device is at least loadable with a processing algorithm and is thus able and configured to calculate and present the output signal as algorithmic resultant of at least the microphone signals from the first microphone and the at least one further microphone.

2. Listening device as claimed in claim 1, characterized in that the second device housing is intended and configured to be worn outside the auditory canal on an auricle of the user, and that the second part of the electronic circuit comprises at least one further microphone provided close to an upper side of the second device housing.

3. Listening device as claimed in claim 1, characterized in that the signal processing device loaded with the processing algorithm is able and configured to apply a time correction between the microphone signal from the first microphone on the one hand and the one or more microphone signals from the at least one further microphone on the other.

4. Listening device as claimed in claim 2, characterized in that the at least one further microphone comprises a group of a number of spatially separated microphones provided close to an upper side of the second device housing.

5. Listening device as claimed in claim 1, characterized in that the second part of the electronic circuit comprises at least one further microphone provided on a rear side of the second device housing.

6. Listening device as claimed in claim 5, characterized in that the at least one further microphone comprises a group of a number of spatially separated microphones provided on a rear side of the second device housing.

7. Listening device as claimed in claim 1, characterized in that the first part of the electronic circuit comprises in the in-the-ear part at least one further microphone with a sound entrance oriented toward an eardrum of the user.

8. Listening device as claimed in claim 1, characterized in that the first part of the electronic circuit comprises at least one further microphone in the in-the-ear part with a sound entrance oriented toward an entrance of the auditory canal.

9. Listening device as claimed in claim 8, characterized in that the at least one further microphone comprises a group of a number of spatially separated microphones, each with a sound entrance oriented toward the entrance of the auditory canal.

10. Listening device as claimed in claim 1, characterized in that the second device housing is received in a deformable sleeve which is able and configured to adjust itself to a local natural anatomy of the auditory canal.

11. Listening device as claimed in claim 10, characterized in that the sleeve comprises at least one ventilating channel which provides an open air pathway between a proximal side facing toward an entrance of the auditory canal and an opposite distal side thereof facing toward the eardrum.

12. Listening device as claimed in claim 1, characterized in that the second part of the electronic circuit in the second device housing comprises at least the signal processing device and an electronic power supply.

13. Listening device as claimed in claim 1, characterized in that the first part of the electronic circuit and the second part of the electronic circuit are mutually connected by means of a cable connection between the first device housing and the second device housing, and that the cable connection comprises on at least one outer end a connector for a releasable connection to at least one of the first device housing and the second device housing.
